(19) United States
(12) Patent Application Publication
(10) Pub. No.: US 2016/0096940 A1
(43) Pub. Date: Apr. 7, 2016

(54) SMOOTH MILLED POLYMERIC FOAM ARTICLE

(71) Applicant: DOW GLOBAL TECHNOLOGIES LLC, Midland, MI (US)

(72) Inventors: Fabio O. D'Ottaviano, Hirzel (CH); Lawrence S. Hood, Midland, MI (US); Jean-Francois Koenig, Horgen (CH); John Gordon- Duffy, Zurich (CH)

(21) Appl. No.: 14/785,640

(22) PCT Filed: Jun. 9, 2014
(86) PCT No.: PCT/US2014/041456

§ 371 Date: Oct. 20, 2015

Related U.S. Application Data
(60) Provisional application No. 61/837,682, filed on Jun. 21, 2013.
(60) Provisional application No. 61/837,219, filed on Jun. 20, 2013.

(51) Int. Cl. C08J 9/12; B29B 9/12; B29B 9/02

(52) U.S. Cl. CPC C08J 9/127; B29B 9/02; B29B 9/12; C08J 2203/14; C08J 2203/12; C08J 2203/10; C08J 2325/06; B29K 2025/06

(57) ABSTRACT

An article includes an extruded polystyrene foam that is characterized by being a singular polymer foam that is free of halogenated blowing agents, having a milled primary surface, having a width of 750 millimeters or more, and further characterized by having a ρ(CST/CSP) value that is 50 kilograms per cubic meter or less and a milled primary surface.

### BACKGROUND OF THE INVENTION

1. Field of the Invention

The present invention relates to a milled polymer foam article and a method for preparing a milled polymer foam article.

2. Introduction

Extruded polystyrene (XPS) foam has utility in many applications including thermal insulation and acoustical attenuation. XPS foam board also has utility as a backerboard for use in showers, bathroom floors, steam rooms and other wet environments. Backerboards serve as substrates that provide a smooth surface over which an adhesive is applied and then a finishing material such as tile is applied. XPS foam backerboards serve as a moisture barrier, provide some thermal insulating character, are light-weight for easy handling and can be readily cut or milled into any desirable shape. XPS backerboards desirably have a smooth surface to accommodate tiling or other finish materials so as to produce flat surfaces. Historically, XPS foam board has enjoyed all of these properties provided the foam board was made using a fluorinated blowing agent such as 1-chloro-1,1-difluoroethane (HFC-142b) or 1,1,1,2-tetrafluoroethane (HFC-134a). Recently, there is a push to eliminate fluorinated blowing agents due to concerns over how fluorinated blowing agents may affect the environment. Therefore, there is a need to find a way to produce an XPS foam that has a smooth surface after face milling yet that is made without using a halogenated blowing agent. An added challenge is to prepare such XPS foam having a width of at least 750 millimeters.

### BRIEF SUMMARY OF THE INVENTION

The present invention provides a solution to the problem of obtaining XPS foam that has a smooth surface after face milling yet that is made without using halogenated blowing agents. In particular, the present invention provides such XPS foam that has a width of at least 750 millimeters and preferably is 800 millimeters or more wide.

The present invention is a result of overcoming challenges in trying to make a singular extruded polystyrene foam that has a width of at least 750 millimeters and that can be milled to a smooth surface without using halogenated blowing agents and, in particular, when using a carbon dioxide blowing agent. Preparing such extruded polystyrene foam proved difficult in an absence of a halogenated blowing agent. Halogenated blowing agents tend to have a low diffusivity in a polymer resin during expansion of the resin into foam. As a result of the low diffusivity of the blowing agent, the expanding polymer resin remains plasticized by the blowing agent during expansion and can readily be directed into a wide shape as it expands. In contrast, blowing agents that have diffusivity in a polymer resin that is significantly higher than that of halogenated blowing agents escape from a polymer resin more quickly than halogenated blowing agents and, thereby, fail to plasticize the resin during expansion for as long. As a result, an expanding polymer resin blown with a high diffusivity blowing agent is less shapeable during expansion making it difficult to direct into wide shapes. Preparing polymer foam with carbon dioxide blowing agent, particularly when carbon dioxide is the primary blowing agent (more than 50 mole-percent of the total blowing agent composition) is especially difficult because of the extremely high diffusivity of carbon dioxide from polymer resins such as styrenic resins.

The inventors have discovered how to prepare XPS foam having a width of at least 750 millimeters and that has a smooth surface after face milling by using a blowing agent package that is free of halogenated blowing agents and that contains carbon dioxide, preferably when carbon dioxide is the primary blowing agent. The inventors have also discovered that such XPS foam must have a ρ(CST/CSP) value that is 50 kilograms per cubic meter or less where ρ is the density of the XPS foam, CST is the compressive strength measured in the thickness dimension of the XPS foam and CSP is the compressive strength measured in an orientation perpendicular to the thickness dimension. Hence, the inventors have discovered that halogenated blowing agent-free XPS foam with a density multiplied by (CST/CSP) that is 50 kilograms per cubic meter or less is particularly well suited for face milling to produce a smooth milled surface.

In a first aspect, the present invention is an article comprising an extruded polystyrene foam, the extruded polystyrene foam characterized by being a singular polymer foam that is free of halogenated blowing agents, having a milled primary surface, having a width of 750 millimeters or more, and further characterized by having a ρ(CST/CSP) value that is 50 kilograms per cubic meter or less and a milled primary surface.

In a second aspect, the present invention is a process for preparing the article of the first aspect, the process comprising: (a) preparing the extruded polystyrene foam by an extrusion foaming method that comprises extruding a foamable polymer mixture through a die and allowing the foamable polymer mixture to expand into a single polymer foam having a width of 750 millimeters or more, the foamable polymer mixture characterized by comprising a styrene polymer and a blowing agent package comprising carbon dioxide at a concentration of 2.0 weight percent or more and 3.0 weight percent or less of carbon dioxide based on styrene polymer weight and by being free of halogenated blowing agents; and (b) milling a primary surface of the extruded polystyrene foam; where the extruded polystyrene foam is further characterized by having a ρ(CST/CSP) value that is 50 kilograms per cubic meter or less.

The process of the present invention is useful for preparing foam of the present invention. The foam of the present invention is useful as XPS foam backerboards in construction applications.

### DETAILED DESCRIPTION OF THE INVENTION

Test methods refer to the most recent test method as of the priority date of this document unless a date is indicated with the test method number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institute für Normung; and ISO refers to International Organization for Standards.

“And/or” means “and, or as an alternative”. All ranges include endpoints unless otherwise indicated.

The article of the present invention comprises an extruded polystyrene foam. Extruded polystyrene foam articles have three mutually perpendicular orientations: extrusion orientation, vertical orientation and horizontal orientation. The extrusion orientation is parallel with the direction the foam is extruded from a foaming die during manufacture. The vertical orientation is parallel to the foaming die opening height during manufacture. The horizontal orientation is parallel to the foaming die opening width during manufacture.

The extruded polystyrene foam also has three mutually perpendicular dimensions: length, width and thickness. The length dimension lies along the longest dimension of a foam article and typically is along the extrusion direction of an extruded foam article. The thickness dimension is the dimension that has the smallest magnitude but can be equal to the length in a cube. The thickness dimension typically is parallel to (that is, the thickness is measured along) the vertical orientation of an extruded foam. Width is mutually perpendicular to length and thickness and can have a magnitude equal to or less than the length and equal to or greater than the thickness. The width of extruded polymer foam typically corresponds to the horizontal orientation of the foam.

Polymer foam articles of the present invention have a primary surface. A primary surface of an article is a surface having a planar surface area equal to the largest planar surface area of the article. A planar surface area is the area of a surface calculated from a projection of that surface onto a plane so as to exclude surface contours in the surface area calculation. The primary surface of the extruded polystyrene foam is in a plane that contains the width (which is generally along the horizontal orientation) and length (which is generally along the extrusion orientation) of the extruded polystyrene foam while being perpendicular to the thickness (which is generally along the vertical orientation) of the extruded polystyrene foam.

Extruded foam is distinct from expanded foam (also known as bead foam or expanded bead foam) or molded foam. Extruded foam is free of a network of polymer skins that surround groups of cells throughout the foam article that are characteristic of expanded foam due to the coalescence of multiple foam particles or beads. Polymer skins are polymer films that are thicker than the average cell wall thickness within the foam. Molded foam can comprise or be free of the network of polymer skins characteristic of expanded foam. However, molded foam has a skin that fully surrounds the foam article that forms as a foamable polymer mixture expanding into a foam contacts the walls of a mold during manufacture. Molded foam is made by filling a mold with foamable polymer mixture and then expanding the foamable polymer mixture to fill the space of the mold. It is a discontinuous process that requires filling a mold and then waiting until foam forms within the mold and is removed before refilling the mold.

Desirably, the extruded polystyrene foam of the present invention is monolithic or singular polymer foam. Singular polymer foam is distinct from a laminated polymer foam article. Laminated polymer foam articles comprise multiple foam components adhered together and possess a characteristic weld line between foam components. The weld line can be, for example, an adhesive layer or an inhomogeneity in foam cell structure between the two foams. Often, the weld line corresponds to a layer of polymer skin (skin layer) between two foams where the foams have been fused together (for example, melt welded together). Laminated foams include foam articles comprising or consisting of layers of foam pieces adhered together and also foam articles comprising or consisting of strands of foam adhered to one another (strand foam). Laminated polymer foam articles further include expanded foam comprising beads of foam adhered together. Singular foam is free of weld lines characteristic of laminated foam articles and, in particular, free of skin layers extending through the foam between foam pieces.

The extruded polymer foam of the present invention is extruded polystyrene foam. Extruded polystyrene foam is extruded foam that comprises a continuous matrix of styrenic polymer that defines multiple cells therein to form polymeric foam. The styrenic polymer can be polystyrene homopolymer, a copolymer of styrene with another monomer such as acrylonitrile or a blend of different polystyrene homopolymers, styrenic copolymers or polystyrene homopolymer(s) with styrenic copolymer(s). Desirably, the styrenic polymer is polystyrene homopolymer or a blend of different polystyrene homopolymers. A polymer foam comprising, preferably consisting of, polystyrene homopolymer as the continuous polymer matrix is polystyrene homopolymer foam.

The extruded polystyrene foam is free of halogenated blowing agents. Halogenated blowing agents include partially and fully halogenated hydrocarbons and, generally, include any carbon backbone with one or more than one halogen attached to it. Blowing agents are distinct from other halogenated materials that may be present (for example, as flame retardants) based on vapor pressure. Blowing agents have a vapor pressure of at least two kiloPascals at 25° C.

The extruded polystyrene foam has a width of 750 millimeters (mm) or more, preferably 800 mm or more. As noted above, the extruded polystyrene foam is also desirably singular extruded polystyrene foam.

Surprisingly, it has been discovered in developing this invention that an extruded polystyrene foam is particularly well suited for face milling, that is milling of its primary surface, to a smooth surface if it has a value of ρ(CST/CSP) that is 50 kilograms per cubic meter (kg/m³) or less, preferably 45 kg/m³ or less, more preferably 40 kg/m³ or less where p is the density of the extruded polystyrene foam, CST is the compressive strength in the thickness dimension of the extruded polystyrene foam and CSP is the compressive strength in a dimension (“Perpendicular” dimension) in the plane of the primary surface and perpendicular to the thickness dimension of the extruded polystyrene foam. Determine density according to DIN EN 1602. Determine compressive strengths according to DIN EN 826.

The present invention is a result of surprisingly discovering that milling a primary surface of an extruded polystyrene foam by advancing (“feeding”) either or both a cutting head and the extruded polystyrene foam past one another in a direction mutually perpendicular to both the thickness dimension and the Perpendicular dimension of the foam results in a particularly smooth milled surface, even when feeding at a relatively rapid rate during milling.

For instance, it is common for an extruded polystyrene foam board to have a thickness corresponding to its vertical orientation, a width corresponding to its horizontal orientation and a length corresponding to its extrusion orientation. Face milling of such a board involves milling the primary face defined by the width and length of the extruded polystyrene foam board using a cutter that rotates about an axis parallel to the thickness (vertical) dimension as the board is fed past the cutter (or the cutter is fed past the board, or as both are fed past one another) along the extrusion orientation of the extruded polystyrene foam board. The surprising discovery of the present invention is in such a case that a particularly smooth milled primary surface is achievable when ρ (CSV/CSH) is 50 kg/m³ or less where ρ is the density of the extruded polystyrene foam board and CSV and CSH are respectively the compressive strengths of the extruded polystyrene foam board in the vertical and horizontal orientation and feeding during milling occurs along the extrusion orientation along the primary face of the foam. In this case, CSV is the compressive strength in the thickness dimension of the extruded polystyrene foam (CST) and CSH is the compressive strength in a dimension (“Perpendicular” dimension) in the plane of the primary surface and perpendicular to the thickness dimension of the extruded polystyrene foam (CSP).

In one desirable embodiment the product of density and both the ratio of CST to the compressive strength in two orientations that are perpendicular to one another and the thickness orientation (for example, (CSV/CSH) and (CSV/CSE) when CST is CSV and where CSE is the compressive strength along the extrusion orientation) is 50 kg/m³ or less. In this embodiment, smooth milling is most likely to occur when feeding in any direction in the plane containing the extrusion and horizontal orientations.

The inventors have discovered that the roughness of a face milled foam surface is directly dependent upon foam density and CST and inversely dependent upon CSP. An increase in foam density typically corresponds to an increase in material through which a cutter must mill, which in turn can result in greater friction and a risk of melting rather than cutting the polymer foam. Melting produces a less smooth and less desirable surface appearance. Increasing CST increases the resistance the foam provides to translating a cutter across a foam surface and, like an increase in density, can result in melting rather than cutting. An increase in CSP on the other hand, can actually decrease surface roughness of a milled surface. CSP corresponds to a foam strength dimension in the plane in which the cutter is spinning and translating. If CSP gets too low there is a tendency for the cutter to bend or deform the polymer over rather than cut the polymer off from the foam. Polymer that is bent instead of removed contributes to surface roughness. Therefore, increased CSP actually tends to result in a smoother face milled foam surface. The inventors have discovered that a particularly smooth surface is achieved when the value of ρ(CST/CSP) is 50 kg/m³ or less. The absolute value of how smooth a surface is depends on a number of characteristics of the milling procedure including what type of cutter is used (for example, how many cutting surfaces and how sharp each surface is), the speed at which the cutter is rotating and the feed rate during milling as well as how surface smoothness is measured. For the sake of characterizing smoothness herein, mill a primary surface of extruded polystyrene foam according to the method described with the Examples (“Face Milling Method”) and characterize the smoothing according to the method described with the Examples (“Smoothness Determination Method”).

A surprising and desirable characteristic of the extruded polystyrene foam of the present invention is that a primary surface of the foam has a roughness value (Ra) of 150 microns or less, preferably 100 microns or less as determined by the Smoothness Determination Method after that primary surface has been milled according to the Face Milling Method. This characteristic reveals that the extruded polystyrene foam is especially well suited for milling at a relatively high feed rate to achieve a smooth surface desirable for backerboard applications.

Optimally, the extruded polystyrene foam has a CST of 75 kiloPascals or more, preferably 100 kiloPascals or more, still more preferably 200 kiloPascals or more, even more preferably 250 kiloPascals for more, still more preferably 300 kiloPascals or more and at the same time typically has a CST of 1000 kiloPascals or less. A high CST is desirable to allow the extruded polystyrene foam to be used in load bearing applications. It is further desirable for the thickness dimension to correspond to the vertical orientation of the extruded polystyrene foam.

Desirably, the extruded polystyrene foam has a density of 64 kg/m³ or less, preferably 48 kg/m³ or less and at the same time desirably has a density of 20 kg/m³ or more, preferably 36 kg/m³ or more and can be 38 kg/m³ or more and even 40 kg/m³ or more.

For ease of production, it is desirable that the extruded polystyrene foam have a thickness of 15 mm or more, preferably 18 mm or more, still more preferably 20 mm or more, yet more preferably 50 mm or more, yet even more preferably 100 mm or more and can be 150 mm or more while at the same time it is typical to have a thickness of 250 mm or less, more typically 220 mm or less, and yet more typically 200 mm or less.

The extruded polystyrene foam has a milled primary surface. Face milling is milling of a primary surface of an article, in this case a primary surface of the extruded polystyrene foam. Extruded polystyrene foam has a milled primary surface if it has experienced face milling. Milling is a machining process that uses rotary cutters that spin about an axis to remove material from an article by advancing the article (or cutter or both article and cutter) at a feed rate in a direction at an angle of greater than zero degrees (typically 90 degrees) with respect to the axis of the cutter while the cutter removes material from the article. The spinning cutter removes material from the articles by taking many individual cuts on the article.

Milling is distinct from cutting with a saw or other means of cutting. Unlike cutting with a saw, milling is capable of imparting a concave contour into a primary face of extruded polystyrene foam. For example, the extruded polystyrene foam of the present invention can be in the form of a singular foam shaped into a concave shower floor pan that tapers to an interior location for drainage, desirably with sloped flat surfaces. Such a foam necessarily has a milled primary surface in order to possess a concave primary surface contour, particularly when the contour has sloped flat surfaces.

Prepare the article of the present invention using a process comprising: (a) preparing the extruded polystyrene foam by an extrusion foaming method that comprises extruding a foamable polymer mixture through a die and allowing the foamable polymer mixture to expand into a single polymer foam having a width of 750 millimeters or more, the foamable polymer mixture characterized by comprising a styrene polymer and a blowing agent package comprising carbon dioxide at a concentration of 2.0 weight percent or more and 3.0 weight percent or less, preferably 2.9 weight percent or less of carbon dioxide based on styrene polymer weight and by being free of halogenated blowing agents; and (b) milling a primary surface of the extruded polystyrene foam; where the extruded polystyrene foam is further characterized by having a ρ(CST/CSP) value that is 50 kilograms per cubic meter or less where CST is the compressive strength in the thickness dimension of the extruded polystyrene foam as measured perpendicular to the primary surface and CSP is the compressive strength in a dimension perpendicular to the thickness dimension of the extruded polystyrene foam and ρ is the density of the extruded polystyrene foam.

In one desirable embodiment, the blowing agent package comprises, or consists of carbon dioxide, water, isobutane and ethanol.

The blowing agent is desirably free of dimethyl ether, as is the polymeric foam prepared by the process of the present invention.

The styrene polymer is as described above for the extruded polystyrene foam and is desirably one or a combination of more than one polystyrene homopolymer.

Preparing a singular extruded polystyrene foam with a width of 750 mm or more, especially 800 mm or more is difficult in an absence of halogenated blowing agents and especially in the presence of carbon dioxide blowing agent because the polystyrene is difficult to shape as it expands using a highly diffusing blowing agent such as carbon dioxide without a low diffusing halogenated blowing agent.

### Examples

### Preparation of Extruded Polystyrene Foam

Prepare each Comparative Example (Comp Ex) and Example (Ex) using any conventional extrusion process capable of the foaming parameters set forth herein. In general, prepare a foamable polymer mixture in an extruder at a mixing temperature and initial pressure that precludes expansion of the foamable polymer mixture, cool the foamable polymer mixture and extrude through a foaming die at an extrusion temperature that is lower than the mixing temperature into an atmosphere at a lower pressure than the initial pressure that allows the foamable polymer mixture to expand into polymer foam.

For the Comp Exs and Exs below prepare the foamable polymer mixture by melt blending together a styrene polymer, blowing agents of the blowing agent package and additives at a temperature of approximately 215° C. and at a pressure sufficient to preclude expansion of the blowing agents.

The styrene polymer is a blend of two polystyrene homopolymers: PS-1 (weight average molecular weight (Mw) of 203 kiloDaltons and polydispersity of 2.6) and PS-2 (Mw of 143 kiloDaltons and polydispersity of 3.6). Table 1 discloses the weight percent of each polystyrene polymer relative to total polystyrene polymer weight.

The blowing agent package is disclosed in Table 1 where concentration is reported in parts per hundred (pph) based on total styrene polymer weight for each blowing agent in the blowing agent package.

The additives are: 0.23 pph barium stearate, 0.15 pph pigment concentrate, 0.37 pph linear low density polyethylene (DOWLEX™ LLDPE 2607G, DOWLEX is a trademark of The Dow Chemical Company), talc, tetrasodium pyrophosphate (TSPP) and flame retardant. For concentration of talc, TSPP and flame retardant see Table 1. Concentrations are in pph based on total polystyrene weight. Flame retardants are either hexabromocycicododecane (HBCD) or brominated styrene/butadiene block copolymer (polyFR; EMERALD INNOVATION™ 3000 fire retardant (EMERALD INNOVATION is a trademark of Chemtura Corporation). When the flame retardant is polyFR, the foamable polymer mixture further comprises 0.15 pph epoxidized soybean oil (Plas-Chek™ 775; Plas-Chek is a trademark of Ferro Corporation), 0.29 pph epoxy cresol novolac resin (Araldite™ ECN 1280, Araldite is a trademark of JP Morgan Chase Bank, NA), and 0.17 pph bis (2,4-dicumylphenyl) pentaerythritol diphosphite (Doverphos S9228™, Doverphos S-9228 is a trademark of Dover Chemical Corporation).

Cool the foamable polymer mixture to a foaming temperature as reported in Table 1 and extrude through a slit die into atmospheric pressure (101 kiloPascals) at a polystyrene feed rate as shown in Table 1 (mass flow rate in kilograms per hour per centimeter of die gap width). The discharge pressure at the die is shown in Table 1. Allow the foam slab to cool to room temperature (approximately 23° C.).

Table 1 further reports the foam properties of the Comp Exs and Exs. Determine density of the extruded polystyrene foam according to DIN EN 1602. Determine compressive strengths of the extruded polystyrene foam according to DIN EN 826. Determine vertical cell size of the extruded polystyrene foam according to ASTM D3576. Face mill the Comp Exs and Exs as described below under Face Milling Method. Characterize the smoothness of the milled surface according to the Smoothness Determination Method.

TABLE 1

| | | | | | | |
|---|---|---|---|---|---|---|
| Extruded | | | | | | |
| Polystyrene Foam | Comp Ex A | Ex 1 | Comp Ex B | Ex 2 | Comp Ex C | Ex 3 |

Foamable Polymer Mixture

| | | | | | | |
|---|---|---|---|---|---|---|
| Wt % PS-1 | 35 | 35 | 35 | 35 | 35 | 30 |
| Wt % PS-2 | 65 | 65 | 65 | 65 | 65 | 70 |
| Blowing Agent | | | | | | |
| CO2 (pph) | 3.7 | 2.3 | 3.7 | 2.5 | 3.7 | 2.8 |
| Isobutane (pph) | 0 | 0.6 | 0 | 0.6 | 0 | 1.15 |
| Ethanol (pph) | 0.7 | 1.4 | 0.7 | 1.4 | 0.7 | 0.39 |
| Water (pph) | 0.2 | 0.2 | 0.2 | 0.2 | 0.2 | 0.33 |
| Talc (pph) | 0.05 | 0.05 | 0.05 | 0.1 | 0.05 | 0.05 |
| TSPP (pph) | 0.1 | 0.1 | 0.1 | 0.1 | 0.1 | 0 |
| Flame Retardant | | | | | | |
| HBCD (pph) | 2.25 | 2.5 | 2.25 | 2.5 | 2.25 | 0 |
| PolyFR (pph) | 0 | 0 | 0 | 0 | 0 | 1.74 |

Foaming Properties

| | | | | | | |
|---|---|---|---|---|---|---|
| Styrene polymer | 33.7 | 33.7 | 25.5 | 25.5 | 26.5 | 29.6 |
| feed rate (kg/hr/cm) | | | | | | |
| Foaming | 112 | 113 | 117 | 118 | 119 | 121 |
| Temperature (° C.) | | | | | | |
| Discharge Pressure | 8.2 | 6.5 | 8.5 | 6.6 | 8.2 | 8.7 |
| (megaPascals) | | | | | | |

Foam Properties

| | | | | | | |
|---|---|---|---|---|---|---|
| Vertical Cell Size | 0.5 | 0.5 | 0.42 | 0.44 | 0.50 | 0.46 |
| (mm) | | | | | | |
| Foam Width (mm) | 924 | 924 | 915 | 915 | 1215 | 1215 |
| Foam Thickness | 94 | 94 | 39 | 39 | 39 | 39 |
| (mm) | | | | | | |
| Density (kg/m³) | 42.3 | 43.8 | 39.6 | 39.8 | 38 | 36 |
| CSV (kiloPascals) | 488 | 355 | 358 | 296 | 408 | 346 |
| ρ(CSV/CSH) | 66 | 43 | 70 | 49 | 55 | 36 |
| (kg/m³) | | | | | | |
| ρ(CSV/CSE) | 61 | 37 | 38 | 33 | 56 | 48 |
| (kg/m³) | | | | | | |
| Smoothness | 190 | 133 | 201 | 146 | 211 | 120 |
| (micrometers) | | | | | | |

A comparison of Comp Ex A with Ex 1, Comp Ex B with Ex 2 and Comp Ex C with Ex 3 each reveals that when the ρ(CSV/CSH) value was below 50 kg/m³ the smoothness was below 150 micrometers yet when ρ(CSV/CSH) was above that value the smoothness was greater than 150 micrometers. A 150 micrometer smoothness value is what is required by customers to correspond to a milled surface that is visually acceptable. Formulation and process differences between compared foams are primarily the result of trying to keep density and cell size similar while varying ρ(CSV/CSH).

Face Milling Method

Face mill a foam board having a length of at least one meter and a width of at least 750 millimeters. Position the foam board on a vacuum table and hold the board in place by drawing a vacuum through the table under the board. Use a Holz-Her Pro-master S 7023 CNC milling machine fitted with a Leitz WF 210-2 cutter head to mill two grooves into the foam board along the extrusion (length) dimension of the foam board by translating the milling head along the length of the foam board. Mill one groove centered approximately one quarter of the width of the foam board in from length side of the board and the other groove centered approximately one quarter of the foam board width from an opposing length side of the foam board.

Mill the grooves into the foam board by directing the cutter head into the foam board at cutter rotation speed of 10,000 revolutions per minute in a clockwise direction, at a feed rate of 30 meters per minute and at a depth in the foam thickness dimension of 15 millimeters. Continue milling the length of the foam board at the same depth, feed rate and cutter speed. The resulting milled foam board should have two parallel grooves 15 millimeters deep extending the length of the foam board.

Smoothness Determination Method

Characterize the smoothness of a milled surface of a foam board as milled according the Face Milling Method, above, in the following manner.

Cut a test sample from the face milled foam board using a band saw and by minimizing imprints to the milled surface. The test sample does not contain the first 300 millimeters milled by the milling head so as to avoid anomalies during the start of milling. The test sample should be at least 200 millimeters long (in the foam board length dimension).

Characterize the smoothness of the milled groove using a profilometer. The profilometer is a Mitutoyo CV-3100 (200 millimeter X-axis range) device fitted with a one-sided cut SPH-71/354884 stylus. The characteristics of the profilometer and measurement parameters are in Table 2:

TABLE 2

| Measurement speed | 0.5 | millimeters per second |
|---|---|---|
| Measurement pitch | 0.1 | millimeters |
| Pitch | x-axis | |
| Symmetric Compensation | 0.039 | millimeters |
| Straightness Compensation | none | |
| Stylus radius compensation | 0.0275 | millimeters |
| Arm | straight arm | |
| Attachment direction of stylus | reverse attachment | |
| Measurement direction | downward | |
| Stylus force on sample | 10 | milliNewtons |

Characterize the smoothness of the milled surface by tracing the stylus of the profilometer a distance of at least 150 millimeters in the extrusion direction along the right side of center of the milled groove—that is, along the portion of the groove where the cutter was climb-cutting (traveling in the opposite direction as the cutter head along the foam board).

Classify the raw data collected by the profilometer into classes of roughness as described in DIN 4760:1982-06. Eliminate Class 1 and Class 2 effects from the raw data set and retain Class 3 (“Grooves”) and Class 4 (“score marks, flaking, protuberances”) effects in the following manner. Plot the data in a plot where the x-axis represents the position of the stylus along the length of the foam board and the y-axis represents the contour height measured by the stylus. Fit the data by least square fit to a 4^{th} order polynomial. Regress the quartic model to determine the absolute value for the residual of each data point. Calculate the arithmetic average of the absolute value of the residuals for all of the data points and that arithmetic average is the roughness value (“Ra”) for the milled surface.

What is claimed is:

1. An article comprising an extruded polystyrene foam, the extruded polystyrene foam characterized by being a singular polymer foam that is free of halogenated blowing agents, having a milled primary surface, having a width of 750 millimeters or more, and further characterized by having a ρ(CST/CSP) value that is 50 kilograms per cubic meter or less and a milled primary surface where ρ corresponds to the extruded polystyrene foam density, CST corresponds to compressive strength of the foam in its thickness dimension and CSP corresponds to compressive strength of the foam in a dimension perpendicular to the thickness dimension of the foam.

2. The article of claim 1, further characterized by the extruded polystyrene foam having a density that is 36 kilograms per cubic meter or more and 48 kilograms per cubic meter or less.

3. The article of claim 1, further characterized by the extruded polystyrene foam having a thickness of 15 millimeters or more and 220 millimeters or less.

4. The article of claim 1, further characterized by the extruded polystyrene foam having a CSV of greater than 200 kiloPascals.

5. The article of claim 1, further characterized by the polystyrene foam being polystyrene homopolymer foam.

6. A process for preparing the article of claim 1, the process comprising:
(a) preparing the extruded polystyrene foam by an extrusion foaming method that comprises extruding a foamable polymer mixture through a die and allowing the foamable polymer mixture to expand into a single polymer foam having a width of 750 millimeters or more, the foamable polymer mixture characterized by comprising a styrene polymer and a blowing agent package comprising carbon dioxide at a concentration of 2.0 weight percent or more and 3.0 weight percent or less of carbon dioxide based on styrene polymer weight and by being free of fluorinated blowing agents; and
(b) milling a primary surface of the extruded polystyrene foam;
where the extruded polystyrene foam is further characterized by having a ρ(CST/CSP) value that is 50 kilograms per cubic meter or less where ρ corresponds to the extruded polystyrene foam density, CST corresponds to compressive strength of the foam in its thickness dimension and CSP corresponds to compressive strength of the foam in a dimension perpendicular to the thickness dimension of the foam.

7. The process of claim 6, further characterized by the blowing agent package comprising water, isobutane and ethanol.

8. The process of claim 6, further characterized by the styrene polymer being polystyrene homopolymer.

9. The process of claim 6, further characterized by preparing the polymer foam in an absence of dimethyl ether.

10. The process of claim 6, where the blowing agent package comprises carbon dioxide, isobutane, ethanol and water.

11. The process of claim 10, where the blowing agent package consists of carbon dioxide, isobutane, ethanol and water.
